(19) United States
(12) Patent Application Publication
(10) Pub. No.: US 2021/0124110 A1
(43) Pub. Date: Apr. 29, 2021

(54) BACKLIGHT

(71) Applicant: Samsung Display Co., Ltd., Yongin-Si (KR)

(72) Inventors: Young Min PARK, Yongin-si (KR); Hyuk Hwan KIM, Yongin-si (KR); Sun Hee OH, Yongin-si (KR); Kang Woo LEE, Yongin-si (KR)

(21) Appl. No.: 17/064,651

(22) Filed: Oct. 7, 2020

(30) Foreign Application Priority Data
Oct. 29, 2019 (KR) 10-2019-0135666

(51) Int. Cl. F21V 8/00

(52) U.S. Cl. CPC G02B 6/0068; G02B 6/0025; G02B 6/0026

(57) ABSTRACT

Provided herein may be a backlight including a light source board, light sources positioned on the light source board, an angular filter disposed on the light source board and the light sources, a first light guide layer configured to disposed between the light source board and the angular filter and to cover the light sources, and a second light guide layer disposed on the angular filter.

### CROSS-REFERENCE TO RELATED APPLICATION

The present application claims priority to Korean patent application number 10-2019-0135666 filed on Oct. 29, 2019, the entire disclosure of which is incorporated herein in its entirety by reference.

### BACKGROUND

### (a) Field

Various embodiments of the present disclosure relate to a backlight. More particular, various embodiments of the present disclosure relate to a backlight which can reduce a thickness and provide light of uniform luminance.

### (b) Description of Related Art

With the development of information technology, the importance of a display device that is a connection medium between a user and information has been emphasized. Owing to the importance of the display device, the use of various display devices such as a liquid crystal display (LCD) device, an organic light-emitting display (OLED) device, and a plasma display (PDP) device has increased.

The liquid crystal display (LCD) device may display an image frame by constantly emitting light from light sources of a backlight and adjusting the amount of light transmitted from each pixel of a display panel.

Thus, it is essential to reduce the thickness of the backlight in order to reduce the thickness of the liquid crystal display device.

However, if the thickness of the backlight is not sufficiently large, light emitted from the light sources is not sufficiently diffused so that a user may recognize a difference in luminance between portions where the light sources are located and portions where no light source is located (e.g., hot spot issue). Thus, a novel method to reduce a thickness of a backlight and provide uniform luminance is needed.

### SUMMARY

Various embodiments of the present disclosure are directed to a backlight which can reduce a thickness and provide light of uniform luminance.

Various embodiments of the present disclosure are directed to a backlight that can show a luminance level similar to that of a conventional backlight even with a smaller number of light sources.

An embodiment of the present disclosure may provide a backlight including a light source board, light sources disposed on the light source board, an angular filter disposed on the light source board and the light sources, and a first light guide layer disposed between the light source board and the angular filter and covering the light sources.

In an embodiment, the first light guide layer may be a transparent resin layer.

In an embodiment, the first light guide layer may be made of silicon resin.

In an embodiment, the angular filter may include a plurality of polymer layers.

In an embodiment, the plurality of polymer layers may have a structure in which first and second polymer layers may be alternately stacked.

In an embodiment, the first and second polymer layers may have different refractive indices.

In an embodiment, the angular filter may have first light transmissivity in a first incident-angle range that may be lower than second light transmissivity in a second incident-angle range, and incident angle of the first incident-angle range may be smaller than incident angle of the second incident-angle range.

In an embodiment, the first incident-angle range may include incident angles of about 30 degrees or less, the second incident-angle range may include incident angles of about 50 to about 70 degrees, the first light transmissivity may be less than about 10%, and the second light transmissivity may be about 40% or more.

In an embodiment, the backlight may further include a second light guide layer positioned on the angular filter, wherein the second light guide layer may include light output patterns.

In an embodiment, the second light guide layer may include a first region and a second region having the same area, the first region may overlap at least one of the light sources, the second region may not overlap any of the light sources, and a sum of areas of the light output patterns in the first region may be smaller than a sum of areas of the light output patterns in the second region.

In an embodiment, the light output patterns may include a first light output pattern, a second light output pattern, and a third light output pattern that are sequentially arranged in a first direction, a distance between a center of the first light output pattern and a center of the second light output pattern may be equal to a distance between the center of the second light output pattern and a center of the third light output pattern, an area of the second light output pattern may be larger than an area of the first light output pattern, and an area of the third light output pattern may be larger than an area of the second light output pattern.

In an embodiment, the light output patterns may further include a fourth light output pattern and a fifth light output pattern that may be sequentially arranged in a second direction different from the first direction from the first light output pattern, a distance between the center of the first light output pattern and a center of the fourth light output pattern may be equal to a distance between the center of the fourth light output pattern and a center of the fifth light output pattern, an area of the fourth light output pattern may be larger than the area of the first light output pattern, and an area of the fifth light output pattern may be larger than the area of the fourth light output pattern.

In an embodiment, the light output patterns may include a first light output pattern, a second light output pattern, and a third light output pattern that are sequentially arranged in a first direction, areas of the first light output pattern, the second light output pattern, and the third light output pattern may be equal to each other, and a distance between a center of the first light output pattern and a center of the second light output pattern may be larger than a distance between the center of the second light output pattern and a center of the third light output pattern.

In an embodiment, the light output patterns may further include a fourth light output pattern and a fifth light output pattern that are sequentially arranged in a second direction different from the first direction from the first light output pattern, areas of the first light output pattern, the fourth light output pattern, and the fifth light output pattern may be equal to each other, and a distance between a center of the first light output pattern and a center of the fourth light output pattern may be larger than a distance between the center of the fourth light output pattern and a center of the fifth light output pattern.

Another embodiment of the present disclosure may provide a backlight including a light source board, light sources disposed on the light source board, and a light guide layer disposed on the light source board and the light sources, wherein the light guide layer may include light output patterns, the light guide layer may include a first region and a second region having the same area, the first region may overlap at least one of the light sources, the second region may not overlap any of the light sources, and an area of the light output patterns in the first region may be smaller than an area of the light output patterns in the second region.

In an embodiment, the light output patterns may include a first light output pattern, a second light output pattern, and a third light output pattern that are sequentially arranged in a first direction, a distance between a center of the first light output pattern and a center of the second light output pattern may be equal to a distance between the center of the second light output pattern and a center of the third light output pattern, an area of the second light output pattern may be larger than an area of the first light output pattern, and an area of the third light output pattern may be larger than an area of the second light output pattern.

In an embodiment, the light output patterns may further include a fourth light output pattern and a fifth light output pattern that may be sequentially arranged in a second direction different from the first direction from the first light output pattern, a distance between the center of the first light output pattern and a center of the fourth light output pattern may be equal to a distance between the center of the fourth light output pattern and a center of the fifth light output pattern, an area of the fourth light output pattern may be larger than the area of the first light output pattern, and an area of the fifth light output pattern may be larger than the area of the fourth light output pattern.

In an embodiment, the light output patterns may include a first light output pattern, a second light output pattern, and a third light output pattern that may be sequentially arranged in a first direction, areas of the first light output pattern, the second light output pattern, and the third light output pattern may be equal to each other, and a distance between a center of the first light output pattern and a center of the second light output pattern may be larger than a distance between the center of the second light output pattern and a center of the third light output pattern.

In an embodiment, the light output patterns may further include a fourth light output pattern and a fifth light output pattern that may be sequentially arranged in a second direction different from the first direction from the first light output pattern, areas of the first light output pattern, the fourth light output pattern, and the fifth light output pattern may be equal to each other, and a distance between a center of the first light output pattern and a center of the fourth light output pattern may be larger than a distance between the center of the fourth light output pattern and a center of the fifth light output pattern.

In an embodiment, the backlight may further include an angular filter having first light transmissivity in a first incident-angle range that may be lower than second light transmissivity in a second incident-angle range, and incident angle of the first incident-angle range may be smaller than incident angle of the second incident-angle range.

### BRIEF DESCRIPTION OF THE DRAWINGS

FIG. 1 is a diagram illustrating a display device in accordance with an embodiment of the present disclosure;

FIG. 2 is a diagram illustrating a display panel in accordance with an embodiment of the present disclosure;

FIG. 3 is a diagram illustrating a pixel in accordance with an embodiment of the present disclosure;

FIGS. 4 and 5 are diagrams illustrating a backlight in accordance with an embodiment of the present disclosure;

FIGS. 6, 7, and 8 are diagrams illustrating an angular filter in accordance with an embodiment of the present disclosure;

FIG. 9 is a diagram illustrating a second light guide layer in accordance with an embodiment of the present disclosure;

FIG. 10 is a diagram illustrating a second light guide layer in accordance with another embodiment of the present disclosure;

FIG. 11 is a diagram illustrating a diffusion layer in accordance with an embodiment of the present disclosure;

FIGS. 12 and 13 are diagrams illustrating a light-concentrating layer in accordance with an embodiment of the present disclosure;

FIG. 14 is a diagram illustrating a reflective polarizing layer in accordance with an embodiment of the present disclosure;

FIGS. 15 and 16 are diagrams illustrating a reflective polarizing layer in accordance with another embodiment of the present disclosure;

FIG. 17 is a diagram illustrating a backlight in accordance with another embodiment of the present disclosure;

FIG. 18 is a diagram illustrating a color conversion layer;

FIG. 19 is a diagram illustrating the simulation result of the backlight in accordance with another embodiment of the present disclosure;

FIG. 20 is a diagram illustrating a conventional backlight; and

FIG. 21 is a diagram illustrating the simulation result of the conventional backlight.

### DETAILED DESCRIPTION

Hereinafter, several embodiments of the present disclosure will be described in detail with reference to the attached drawings, such that those skilled in the art can easily implement the present disclosure. The present disclosure may be embodied in various different forms without being limited to the following embodiments.

In the drawings, portions which are not related to the present disclosure will be omitted to explain the present disclosure more clearly. Reference should be made to the drawings, in which similar reference numerals are used throughout the different drawings to designate similar components. Therefore, the aforementioned reference numerals may be used in other drawings.

In addition, since the size and thickness of each component shown in the drawings are arbitrarily shown for the convenience of description, the present disclosure is not limited to the drawings. In the drawings, the thickness may be exaggerated for clarity in expressing several layers and regions.

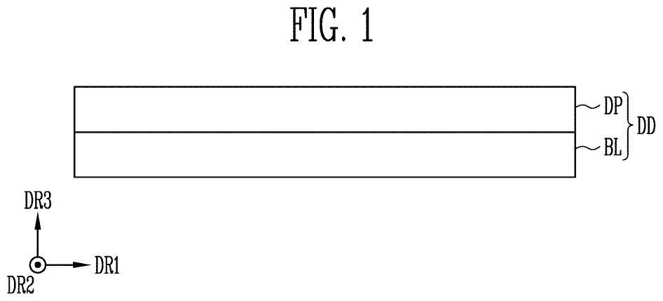

FIG. 1 is a diagram illustrating a display device in accordance with an embodiment of the present disclosure.

Referring to FIG. 1, the display device DD according to the embodiment of the present disclosure may include a display panel DP and a backlight BL.

The display device DD may be a liquid crystal display device or another type of light transmisssive display device. The display panel DP may be a liquid crystal display panel or another type of light transmisssive display panel. The light transmissive display panel refers to a display panel in which at least some pixels of the display panel DP display an image by adjusting the transmission amount of light emitted from a backlight BL. For example, some pixels of the display panel DP may include a self-light emitting device without using the backlight BL as a light source.

The display panel DP may be positioned on the backlight BL. Each of the display panel DP and the backlight BL may have the shape of a plate having a plane extending in a first direction DR1 and a second direction DR2. According to an embodiment, each of the display panel DP and the backlight BL may have the shape of a plate having a curved surface.

The display panel DP may be positioned in a third direction DR3 from the backlight BL. For the convenience of description, it is assumed that the first direction DR1, the second direction, and the third direction DR3 are perpendicular to each other. In the embodiments of the present disclosure, unless otherwise specified, the first direction DR1 and the second direction DR2 may be used to indicate that each drawing is a plan view, and the first direction DR1 and the third direction DR3 may be used to indicate that each drawing is a sectional view or a side sectional view.

Three directions are used to easily describe the three-dimensional configuration of the display device DD, and more various directions may be defined and used in an actual implementation product.

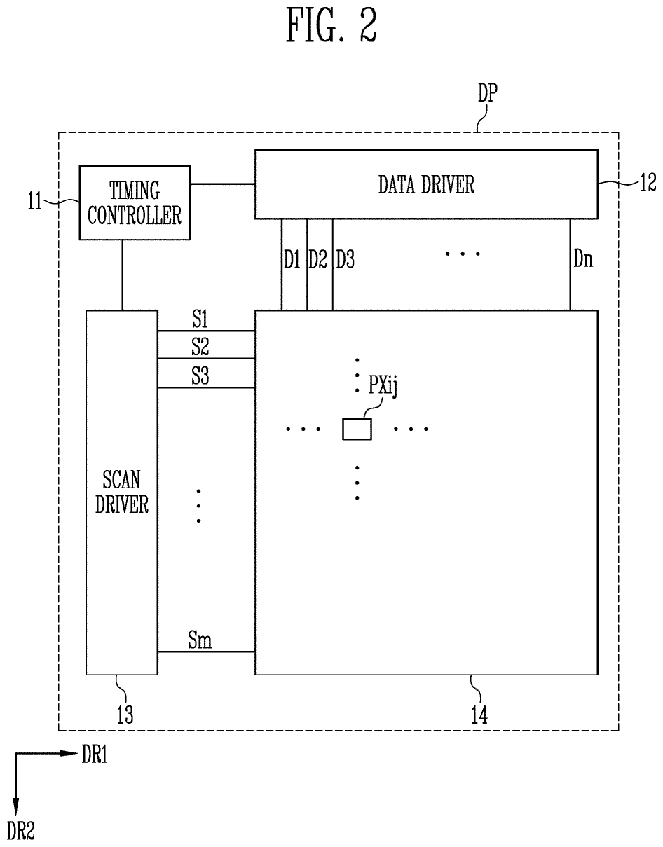

FIG. 2 is a diagram illustrating a display panel in accordance with an embodiment of the present disclosure.

Referring to FIG. 2, the display panel DP in accordance with an embodiment of the present disclosure may include a timing controller 11, a data driver 12, a scan driver 13, and a pixel unit 14.

The timing controller 11 may receive control signals and input gray values for an image frame from an external processor. The timing controller 11 may generate output gray values by compensating, adjusting, or rendering the input gray values. The timing controller 11 may supply the output gray values and the control signals to the data driver 12.

The data driver 12 may generate data voltages that are to be provided to data lines (D1, D2, D3, . . . and Dn) using the output gray values, the control signals and the like. For example, data voltages generated on the basis of a pixel row (e.g. pixels connected to the same scan line) may be simultaneously applied to the data lines from D1 to Dn.

Furthermore, the timing controller 11 may generate a clock signal and a scan start signal corresponding to specifications of the scan driver 13 and supply the clock signal and the scan start signal to the scan driver 13.

The scan driver 13 may receive control signals such as the clock signal and the scan start signal from the timing controller 11 and generate scan signals to the scan lines (S1, S2, S3, . . . and Sm). The scan driver 13 may provide the scan signals through the scan lines from S1 to Sm and thus select pixels to which data voltages are to be written. For example, the scan driver 13 may successively provide scan signals having a turn-on level to the scan lines from S1 to Sm and thus select each pixel row to which data voltages are to be written. Stage circuits of the scan driver 13 may be configured in the form of shift registers and may generate scan signals in such a way that a scan start signal is sequentially transmitted to a subsequent stage circuit under control of a clock signal.

The pixel unit 14 includes a plurality of pixels PXij. Each of the plurality of pixel PXij may be coupled with a corresponding data line and a corresponding scan line. For instance, if data voltages for one pixel row are applied from the data driver 12 to the data lines from D1 to Dn, the data voltages may be written to a pixel row corresponding to a scan line that has received a scan signal having a turn-on level from the scan driver 13.

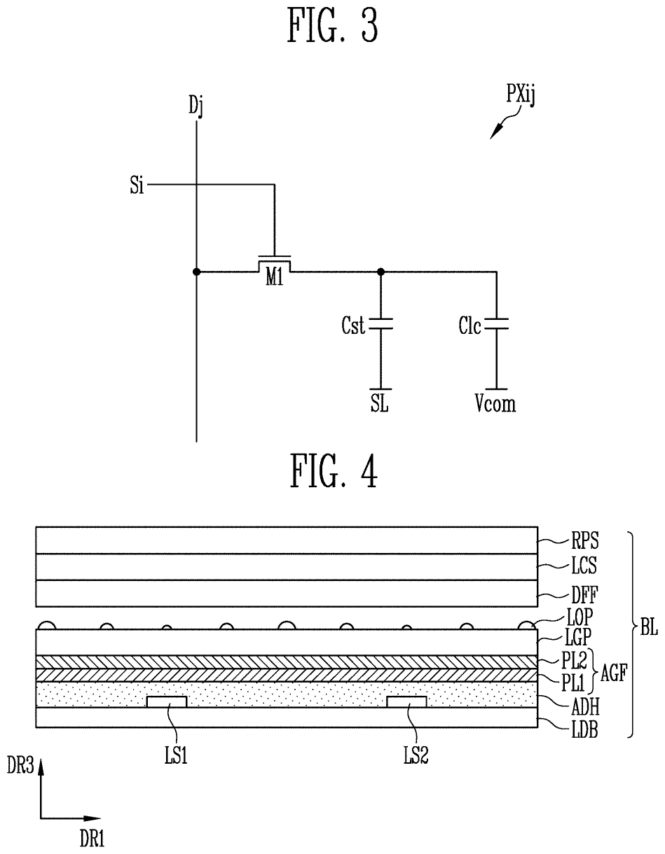

FIG. 3 is a diagram illustrating a pixel in accordance with an embodiment of the present disclosure.

Referring to FIG. 3, the pixel PXij may include a transistor M1, a storage capacitor Cst, and a liquid crystal capacitor Clc.

In this embodiment, since the transistor M1 is illustrated as an N-type transistor, the turn-on level of the scan signal may be a high level. However, in other embodiments, the transistor M1 is a P-type transistor.

A gate electrode of the transistor M1 may be coupled to the scan line Si One electrode of the transistor M1 may be coupled to the data line Dj and the other electrode of the transistor M1 may be coupled to one electrode of the storage capacitor Cst and a pixel electrode of the liquid crystal capacitor Clc.

The other electrode of the storage capacitor Cst may be coupled to a sustain voltage line SL. According to an embodiment, when the capacity of the liquid crystal capacitor Clc is sufficient, the configuration of the storage capacitor Cst may be excluded.

The pixel electrode of the liquid crystal capacitor Clc may be coupled to the common voltage Vcom which may be applied to a common electrode. A liquid crystal layer may be interposed between the pixel electrode of the liquid crystal capacitor Clc and the common electrode. The common electrode may be an electrode shared by a plurality of pixels or all pixels of a pixel unit 14. That is, the same common voltage may be applied to the plurality of pixels or all pixels through the common electrode.

If the scan signal of the turn-on level is supplied through the scan line Si to the gate electrode of the transistor M1, the transistor M1 couples the data line Dj to one electrode of the storage capacitor Cst. Thus, a voltage corresponding to a difference between the data voltage applied through the data line Dj and the sustain voltage of the sustain voltage line SL is stored in the storage capacitor Cst. The liquid crystal capacitor Clc maintains a data voltage on the pixel electrode by the storage capacitor Cst. Thus, an electric field corresponding to a difference between the data voltage and the common voltage may be applied to the liquid crystal layer, and the orientation of liquid crystal molecules of the liquid crystal layer may be determined according to the electric field. Transmissivity may correspond to the orientation of the liquid crystal molecules.

In other embodiments, the display panel DP may further include a polarizing plate, a color filter, and the like according to the configuration of the related art.

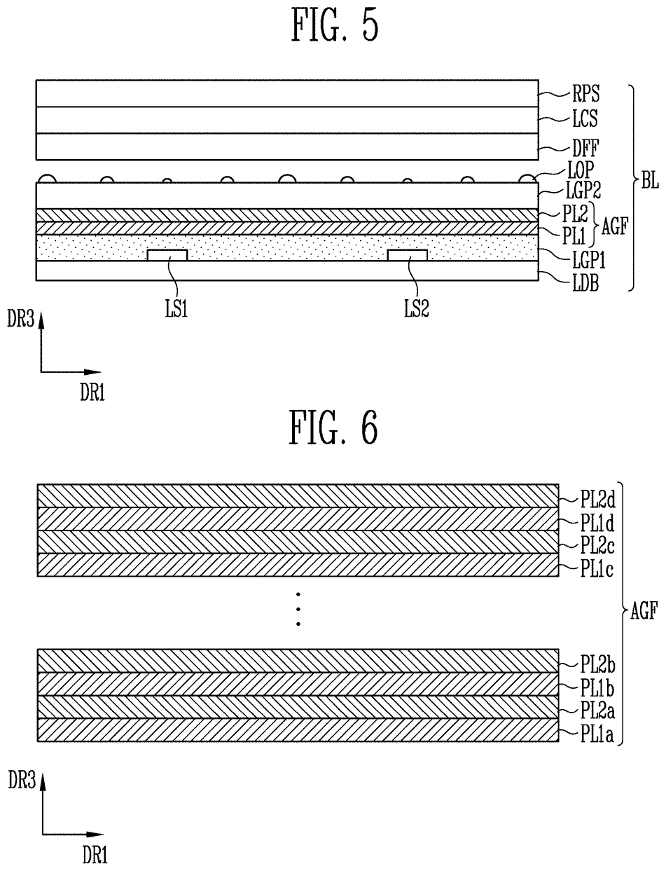

FIGS. 4 and 5 are diagrams illustrating a backlight in accordance with an embodiment of the present disclosure.

Referring to FIG. 4, the backlight BL according to an embodiment of the present disclosure may include a light source board LDB, light sources LS1 and LS2, an adhesive layer ADH, an angular filter AGF, a light guide layer LGP, light output patterns LOP, a diffusion layer DFF, a light-concentrating layer LCS, and a reflective polarizing layer RPS.

The light sources LS1 and LS2 may be positioned on the light source board LDB. The light source board LDB may be an electric circuit such as a printed circuit board (PCB) or a flexible PCB (FPCB). According to another embodiment, the light source board LDB may be a mount for supporting the light sources LS1 and LS2, or a heat dissipation plate for cooling the light sources LS1 and LS2.

The light sources LS1 and LS2 may be a light emitting diode (LED), a cold cathode fluorescent lamp (CCFL), an external electrode fluorescent lamp (EEFL), a flat fluorescent lamp (FFL) and the like. The light sources LS1 and LS2 may emit white light if power is supplied through the light source board LDB. When a separate color conversion layer or color filter is provided, the light sources LS1 and LS2 may be configured to emit light having colors other than white.

The adhesive layer ADH may fill a space between the light source board LDB and the angular filter AGF, and may cover the light sources LS1 and LS2. For example, the adhesive layer ADH may be in contact with the light source board LDB, the angular filter AGF, and the light sources LS1 and LS2. Therefore, according to this embodiment, air gaps may be removed between the light source board LDB, the light sources LS1 and LS2, and the angular filter AGF.

The adhesive layer ADH may be a transparent resin layer. For example, the adhesive layer ADH may include silicon resin. The adhesive layer ADH may serve to adhere the angular filter AGF to the light source board LDB.

The angular filter AGF may be disposed on the light source board LDB and the adhesive layer ADH. The angular filter AGF may have high transmissivity for light that is in a large incident angle range, and low transmissivity for light that is in a small incident angle range. Thus, the light passing through the angular filter AGF may satisfy the total reflection condition of the light guide layer LGP that will be described later. For example, the angular filter AGF may include two polymer layers PL1 and PL2 having different refractive indices. In other embodiments, the angular filter AGF may include more than two polymer layers. The angular filter AGF will be described below in detail with reference to FIGS. 6 to 8.

The light guide layer LGP may be disposed on the angular filter AGF. The light guide layer LGP may be made of polymethylmethacrylate (PMMA), glass, or polyethylene terephthalate (PET).

The light guide layer LGP may include light output patterns LOP. The light output patterns LOP may have a shape in which light diffusion ink is printed on the light guide layer LGP. According to another embodiment, the light output patterns LOP may be an injection-molded product that is formed integrally with the light guide layer LGP. In addition, the light output patterns LOP may be formed on the light guide layer LGP using a roll stamping method.

The light output patterns LOP upwardly emit light that has been totally reflected by the light guide layer LGP. That is, since the refractive index of the light guide layer LGP is greater than that of the air gap above the light guide layer LGP, light may be totally reflected. Here, since the refractive index of the light output patterns LOP is greater than that of the air gap, the refractive index condition among the total reflection conditions may not be satisfied. Furthermore, the light output patterns LOP may not satisfy the critical angle condition among the total reflection conditions due to the shape of an interface (e.g. convex shape). Therefore, the light that has been totally reflected by the light guide layer LGP may be emitted upwardly through the light output patterns LOP.

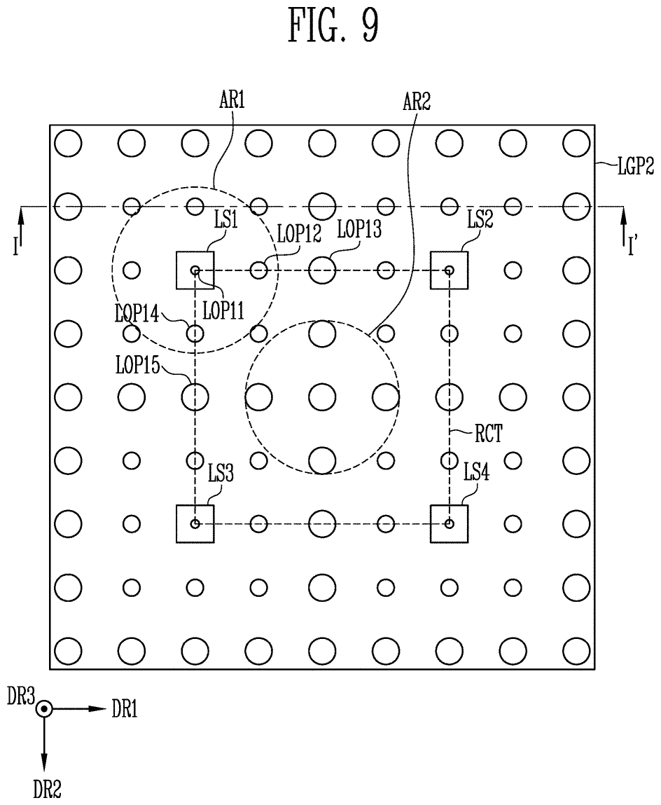

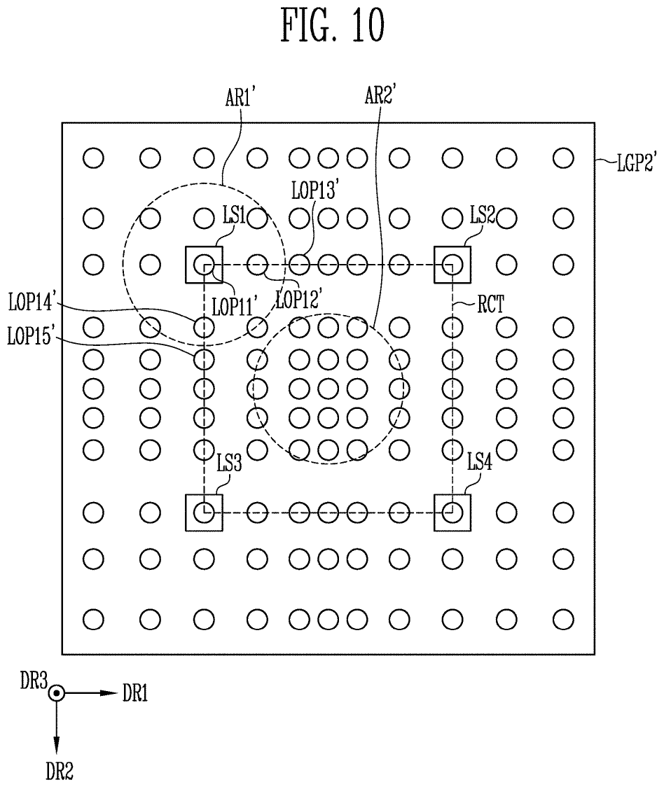

According to this embodiment, the density of the light output patterns LOP located in first regions of the light guide layer LGP, which are adjacent to the light sources LS1 and LS2 in the third direction DR3, may be small, and the density of the light output patterns LOP in second regions of the light guide LGP, which are positioned next to the first regions in the third direction DR3, may be larger than that of the first regions. Thus, uniform light may be emitted from the light guide layer LGP, by suppressing the luminance of the first regions and enhancing the luminance of the second regions. Therefore, the thickness of the backlight BL may be reduced. The light output patterns LOP will be described in more detail with reference to FIGS. 9 and 10.

The diffusion layer DFF may be disposed on the light guide layer LGP and the light output patterns LOP. The diffusion layer DFF may diffuse the light emitted from the light guide layer LGP, and the light output patterns LOP once again may, increase the uniformity of the light. The diffusion layer DFF will be described in more detail with reference to FIG. 11.

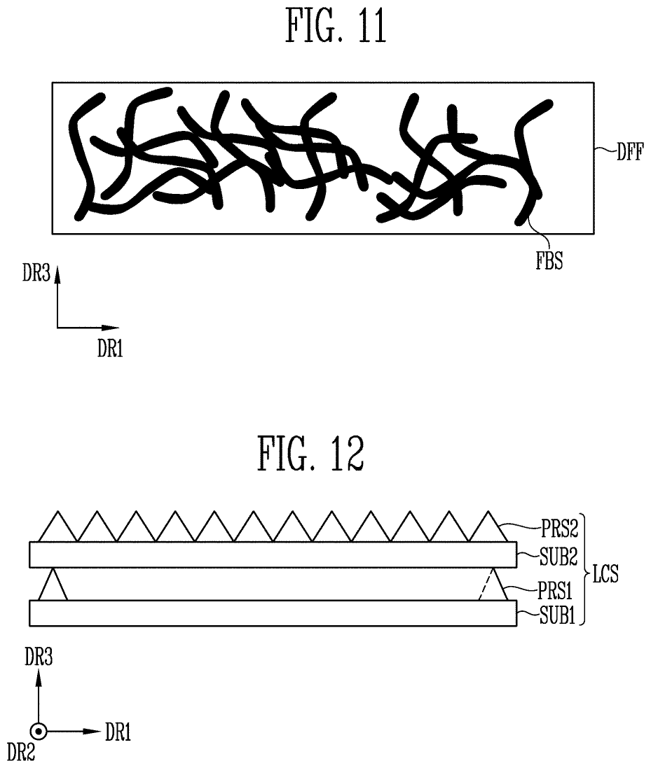

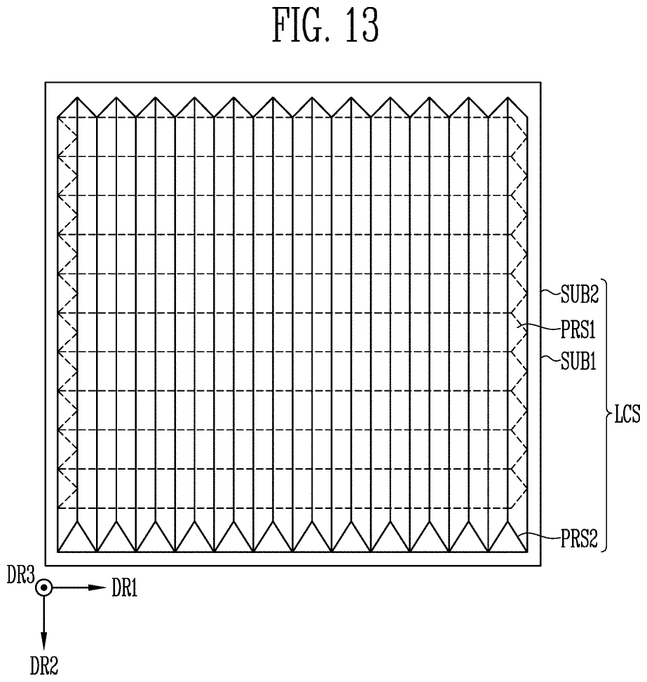

The light-concentrating layer LCS may be positioned on the diffusion layer DFF. The light-concentrating layer LCS may adjust emitted light towards the front of the backlight BL, namely, in the third direction DR3. The light-concentrating layer LCS may be configured such that the display device DD satisfies a desired viewing angle. The light-concentrating layer LCS will be described with reference to FIGS. 12 and 13.

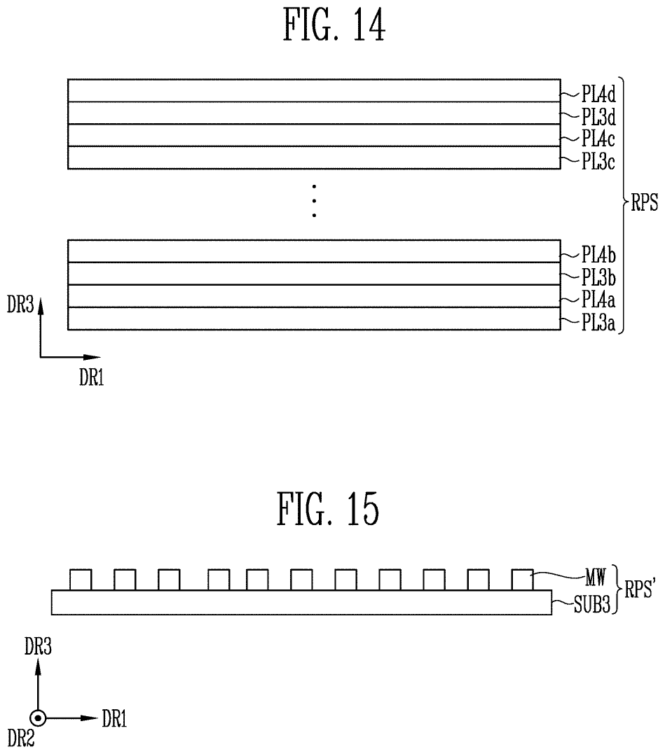

The reflective polarizing layer RPS may be positioned on the light-concentrating layer LCS. The reflective polarizing layer RPS may be a reflective polarizer. The reflective polarizer may increase the energy efficiency and luminance of the backlight BL by reflecting and recycling polarized light that is to be absorbed by the reflective polarizer. The reflective polarizing layer RPS will be described with reference to FIGS. 14 to 16.

FIG. 5 is different from FIG. 4 in that the first light guide layer LGP1 is provided instead of the adhesive layer ADH, and the light guide layer LGP is referred to as a second light guide layer LGP2.

Since the air gap does not satisfy the refractive-index condition among the total reflection conditions, the air gap may not function as the light guide layer. According to this embodiment, by using the first light guide layer LGP1 instead of the air gap, some of the light may be totally reflected below the backlight BL to allow primary diffusion to occur, thus reducing the thickness of the backlight BL.

For example, the first light guide layer LGP1 may be formed of a transparent resin layer such as silicon resin.

For the convenience of description, the following embodiments will be described with reference to FIG. 5, but the embodiment of FIG. 4 is also applicable.

FIGS. 6, 7, and 8 are diagrams illustrating an angular filter in accordance with an embodiment of the present disclosure.

Referring to FIG. 6, the angular filter AGF according to the embodiment of the present disclosure may include a plurality of polymer layers PL1a, PL2a, PL1b, PL2b, PL1c, PL2c, PL1d and PL2d. Each of the polymer layers from PL1a to PL2d may be a dielectric.

The plurality of polymer layers from PL1a to PL2d may be a structure in which a first polymer layer PL1 and a second polymer layer PL2 are alternately stacked. For example, the first polymer layer PL1a, the second polymer layer PL2a, the first polymer layer PL1b, and the second polymer layer PL2b may be sequentially stacked in the third direction DR3.

The first polymer layer PL1 and the second polymer layer PL2 may have different refractive indices. The first polymer layers PL1a, PL1b, PL1c, and PL1d may be made of the same material and have the same or different thicknesses. The second polymer layers PL2a, PL2b, PL2c, and PL2d may be made of the same material and have the same or different thicknesses.

The angular filter AGF may selectively transmit light having a target incident angle by the interference of refracted or reflected light, based on the thickness and refractive index of each polymer layer and the incident angle of light.

FIG. 7 illustrates the light transmissivity for the incident angle, when light having the wavelength of 450 nm is incident on the angular filter AGF.

The angular filter AGF may have first light transmissivity in a first incident-angle range SECT1 that is lower than second light transmissivity in a second incident-angle range SECT2. Incident angles of the first incident-angle range SECT1 may be smaller than incident angles of the second incident-angle range SECT2.

For example, the first incident-angle range SECT1 may include incident angles of about 30 degrees or less. The first light transmissivity in the first incident-angle range SECT1 may be less than about 20%. The first light reflectivity in the first incident-angle range SECT1 may be about 80% or more. The second incident-angle range SECT2 may include incident angles between about 50 to about 70 degrees. The second light transmissivity in the second incident-angle range SECT2 may be about 40% or more. The second light reflectivity in the second incident-angle range SECT2 may be about 60% or less. The aforementioned numerical ranges may be a configuration required to achieve the effects of FIG. 18.

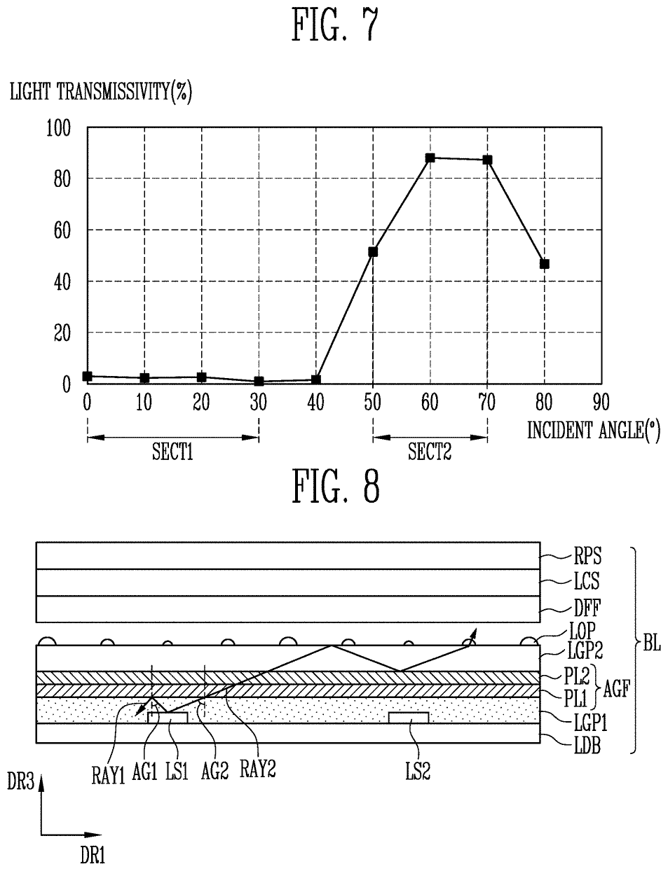

FIG. 8 illustrates that, when first light RAY1 emitted from the first light source LS1 is incident on the angular filter AGF at a first incident angle AG1, the first light RAY1 is reflected by the angular filter AGF. The first incident angle AG1 may be any angle within the first incident-angle range SECT1. The reflected first light RAY1 may be recycled to increase energy efficiency and luminance of the backlight BL.

Furthermore, it is shown that, when second light RAY2 emitted from the second light source LS2 is incident on the angular filter AGF at a second incident angle AG2, the second light RAY2 passes through the angular filter AGF. The second incident angle AG2 may be any angle within the second incident-angle range SECT2. The second light RAY2 passing through the angular filter AGF may satisfy a critical angle condition among the total reflection conditions of the second light guide layer LGP2. The second light RAY2 may be totally reflected in the second light guide layer LGP2 and then emitted upwardly through the light output pattern LOP.

FIG. 9 is a diagram illustrating a second light guide layer in accordance with an embodiment of the present disclosure.

The cross-section taken along line I-I′ of FIG. 9 may correspond to FIGS. 5 and 8.

The second light guide layer LGP2 may include a first region AR1 and a second region AR2 having the same area. The first region AR1 may overlap with at least one of the light sources LS1, LS2, LS3, and LS4. In this case, the term “overlap” may mean that the first region AR1 is positioned in the third direction DR3 from the light sources LS1, LS2, LS3, and LS4. However, the second region AR2 may not overlap the light sources LS1, LS2, LS3, and LS4. The sum of the areas of the light output patterns LOP in the first region AR1 in the first direction may be smaller than the sum of the areas of the light output patterns LOP in the second region AR2 in the first direction. That is, the density of the light output patterns LOP in the first region AR1 may be lower than the density of the light output patterns LOP in the second region AR2. Thus, uniform light may be emitted from the second light guide layer LGP2, by suppressing the luminance of the first region AR1 and enhancing the luminance of the second region AR2.

For example, the light sources LS1, LS2, LS3, and LS4 may be arranged in a lattice form. Based on the smallest rectangular region RCT having the light sources LS1, LS2, LS3, and LS4 as vertices, the second region AR2 may be located inside the rectangular region RCT, and the first region AR1 may have the vertex of the rectangular region RCT as its center. The first region AR1 and the second region AR2 may not overlap with each other. In addition, the first region AR1 and the second region AR2 may be spaced apart from each other.

In the embodiment of FIG. 9, the light output patterns LOP may be uniformly arranged in a lattice shape. The areas of the light output patterns LOP may be gradually changed in respective first and second directions DR1 and DR2.

For example, the light output patterns LOP may include a first light output pattern LOP11, a second light output pattern LOP12, and a third light output pattern LOP13 which are sequentially arranged in the first direction DR1. The first light output pattern LOP11 may be the light output pattern that is closest to the first light source LS1. A distance between the center of the first light output pattern LOP11 and the center of the second light output pattern LOP12 may be equal to a distance between the center of the second light output pattern LOP12 and the center of the third light output pattern LOP13. Here, the area of the second light output pattern LOP12 may be larger than the area of the first light output pattern LOP11, and the area of the third light output pattern LOP13 may be larger than the area of the second light output pattern LOP12. The areas of the light output patterns LOP may be gradually reduced again towards the first direction DR1 (e.g. towards the second light source LS2). That is, the area of each of the light output patterns LOP may be gradually increase from the first light source LS1 to the middle of each of the light output patterns LOP in the first direction DR1 and decrease from the middle of each of the light output patterns LOP to the second light source LS2 in the first direction DR2.

Furthermore, the light output patterns LOP may further include a fourth light output pattern LOP14 and a fifth light output pattern LOP15 that are sequentially arranged from the first light output pattern LOP11 in the second direction DR2 different from the first direction DR1. Although FIG. 8 shows that the first direction DR1 is perpendicular to the second direction DR2, the first direction DR1 may not be perpendicular to the second direction DR2 in another embodiment.

Here, a distance between the center of the first light output pattern LOP11 and the center of the fourth light output pattern LOP14 may be equal to a distance between the center of the fourth light output pattern LOP14 and the center of the fifth light output pattern LOP15. The area of the fourth light output pattern LOP14 may be larger than the area of the first light output pattern LOP11. The area of the fifth light output pattern LOP15 may be larger than the area of the fourth light output pattern LOP14. The areas of the light output patterns LOP may be gradually reduced again towards the second direction DR2 (e.g. towards the third light source LS3). That is, the area of each of the light output patterns LOP may be gradually increase from the first light source LS1 to the middle of each of the light output patterns LOP in the second direction DR2 and decrease from the middle of each of the light output patterns LOP to the third light source LS3 in the second direction DR2.

FIG. 10 is a diagram illustrating a second light guide layer in accordance with another embodiment of the present disclosure.

The second light guide layer LGP2′ may include a first region AR1′ and a second region AR2′ having the same area. The first region AR1′ may overlap at least one of the light sources LS1, LS2, LS3, and LS4. In this case, the term “overlap” may mean that the first region AR1′ is positioned in the third direction DR3 from the first light source LS1. The second region AR2′ may not overlap with the light sources LS1, LS2, LS3, and LS4. The sum of the areas of the light output patterns LOP in the first region AR1′ may be smaller than the sum of the areas of the light output patterns LOP in the second region AR2′. That is, the density of the light output patterns LOP in the first region AR1′ may be lower than the density of the light output patterns LOP in the second region AR2′. Thus, uniform light may be emitted from the second light guide layer LGP2′, by suppressing the luminance of the first region AR1′ and enhancing the luminance of the second region AR2′.

For example, the light sources LS1, LS2, LS3, and LS4 may be arranged in a lattice form. Based on the smallest rectangular region RCT having the light sources LS1, LS2, LS3, and LS4 as vertices, the second region AR2′ may be located inside the rectangular region RCT, and the first region AR1′ may have the vertex of the rectangular region RCT′ as its center. The first region AR1′ and the second region AR2′ may not overlap with each other. The first region AR1′ and the second region AR2′ may be spaced apart from each other.

As depicted in FIG. 10, the areas of the light output patterns LOP may be equal to each other. A distance between the adjacent light output patterns LOP may gradually increase or decrease in the first DR1 and second (DR2) directions respectively.

For example, the light output patterns LOP may include a first light output pattern LOP11′, a second light output pattern LOP12′, and a third light output pattern LOP13′ which are sequentially arranged in the first direction DR1. The first light output pattern LOP11′ may be the light output pattern that is closest to the first light source LS1. The areas of the first light output pattern LOP11′, the second light output pattern LOP12′, and the third light output pattern LOP13′ may be equal to each other. Here, a distance between the center of the first light output pattern LOP11′ and the center of the second light output pattern LOP12′ may be larger than a distance between the center of the second light output pattern LOP12′ and the center of the third light output pattern LOP13′. However, distances between the centers of the adjacent two light output patterns LOP may gradually increase from the middle of the light output pattern LOP to the second light source LS2 along the first direction DR1.

Furthermore, the light output patterns LOP may further include a fourth light output pattern LOP14′ and a fifth light output pattern LOP15′ that are sequentially arranged from the first light output pattern LOP11′ in the second direction DR2. Although FIG. 10 shows that the first direction DR1 is perpendicular to the second direction DR2, the first direction DR1 may not be perpendicular to the second direction DR2 in another embodiment.

Here, the areas of the first light output pattern LOP11′, the fourth light output pattern LOP14′, and the fifth light output pattern LOP15′ may be equal to each other. A distance between the center of the first light output pattern LOP11′ and the center of the fourth light output pattern LOP14′ may be larger than a distance between the center of the fourth light output pattern LOP14′ and the center of the fifth light output pattern LOP15′. However, the distances between the centers of the adjacent two light output patterns LOP may gradually increase from the middle of the light output pattern LOP to the second light source LS2 along the second direction DR2 to the third light source LS3.

FIG. 11 is a diagram illustrating a diffusion layer in accordance with an embodiment of the present disclosure.

Referring to FIG. 11, the diffusion layer DFF may be a fiber diffuser including a plurality of fibers FBS. The diffusion layer DFF may have a structure in which the plurality of fibers FBS is irregularly entangled.

An existing diffusion plate or diffusion sheet includes beads so that diffusion occurs in the diffusion sheet, or includes beads on an outer surface so that diffusion occurs on the outer surface.

The diffusion layer DFF according to the present embodiment may diffuse light on both inner and outer surfaces so that it may have a thin thickness.

FIGS. 12 and 13 are diagrams illustrating a light-concentrating layer in accordance with an embodiment of the present disclosure.

Referring to FIGS. 12 and 13, the light-concentrating layer LCS may include a first substrate SUB 1, first prisms PRS1, a second substrate SUB2, and second prisms PRS2.

The first substrate SUB1 and the second substrate SUB2 may be made of plastics, glass or the like of a transparent material. For example, the first substrate SUB1 and the second substrate SUB2 may be made of a PET material.

The first prisms PRS1 may be disposed on the first substrate SUB1. Each of the first prisms PRS1 may have a triangular rod shape extending along the first direction DR1. Here, the first prisms PRS1 may be arranged along the second direction DR2.

The second substrate SUB2 may be disposed on the first prisms PRS1.

The second prisms PRS2 may be disposed on the second substrate SUB2. Each of the second prisms PRS2 may have a triangular rod shape extending along the second direction DR2. Here, the second prisms PRS2 may be arranged along the first direction DR1.

Light incident on the light-concentrating layer LCS may be refracted by the first prisms PRS1 and the second prisms PRS2 to be directed towards the front of the display panel DP.

The number of the prism layers is not limited. For example, a single light-concentrating layer LCS composed of the first substrate SUB1 and the first prisms PRS1 may be provided. By adding prism layers extending in various directions, the light concentrating ratio of the light emitted towards the front of the display panel DP may be increased, but the thickness of the backlight BL may be increased and light efficiency may be reduced. The number of the prism layers may be appropriately selected by a manufacturer of the backlight BL.

FIG. 14 is a diagram illustrating a reflective polarizing layer in accordance with an embodiment of the present disclosure.

Referring to FIG. 14, the reflective polarizing layer RPS may include a plurality of polymer layers PL3a, PL4a, PL3b, PL4b, PL3c, PL4c, PL3d, and PL4d. Each of the polymer layers from PL3a to PL4d may be a dielectric.

The plurality of polymer layers from PL3a to PL4d may be configured such that third polymer layers PL3a, PL3b, PL3c, and PL3d and fourth polymer layers PL4a, PL4b, PL4c, and PL4d are alternately stacked. The third polymer layers PL3a, PL3b, PL3c, and PL3d and the fourth polymer layers PL4a, PL4b, PL4c, and PL4d may have different refractive indices. The third polymer layers PL3a, PL3b, PL3c, and PL3d and the fourth polymer layers PL4a, PL4b, PL4c, and PL4d may have anisotropy.

If unpolarized light is incident on the reflective polarizing layer RPS, P1 polarizing components have a small refractive-index difference at the interface, so that transmissivity is high, and P2 polarizing components may lead to the coherent addition of reflected components at the interface. Since the P1 polarizing components are used as the light source of the display panel DP and the P2 polarizing components are recycled at the backlight BL, the light efficiency and luminance of the backlight BL may be increased.

According to the embodiment, the backlight BL may further include a bead coating layer on the reflective polarizing layer RPS.

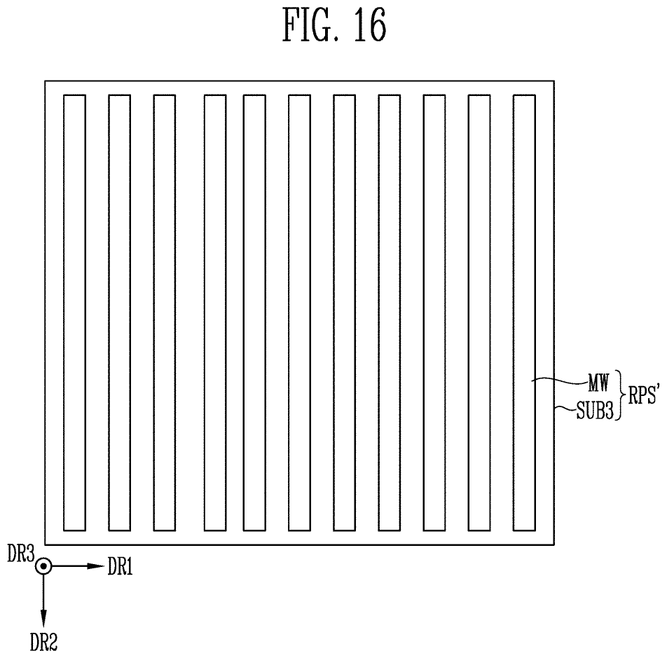

FIGS. 15 and 16 are diagrams illustrating a reflective polarizing layer in accordance with another embodiment of the present disclosure.

Referring to FIGS. 15 and 16, the reflective polarizing layer RPS′ may include a third substrate SUB3 and metal wires (MW) disposed on the third substrate SUB3.

The metal wires MW may extend in the second direction DR2, and may be arranged in the first direction DR1.

The reflective polarizing layer RPS′ may make the P polarizing components of the incident light pass. Furthermore, the reflective polarizing layer RPS′ may make S polarizing components having an amplitude in the first direction DR1 of the incident light pass.

The reflective polarizing layer RPS′ may make S polarizing components having an amplitude in the second direction DR2 of the incident light be reflected. The S polarizing components may be recycled in the backlight BL, thus increasing the light efficiency and luminance of the backlight BL.

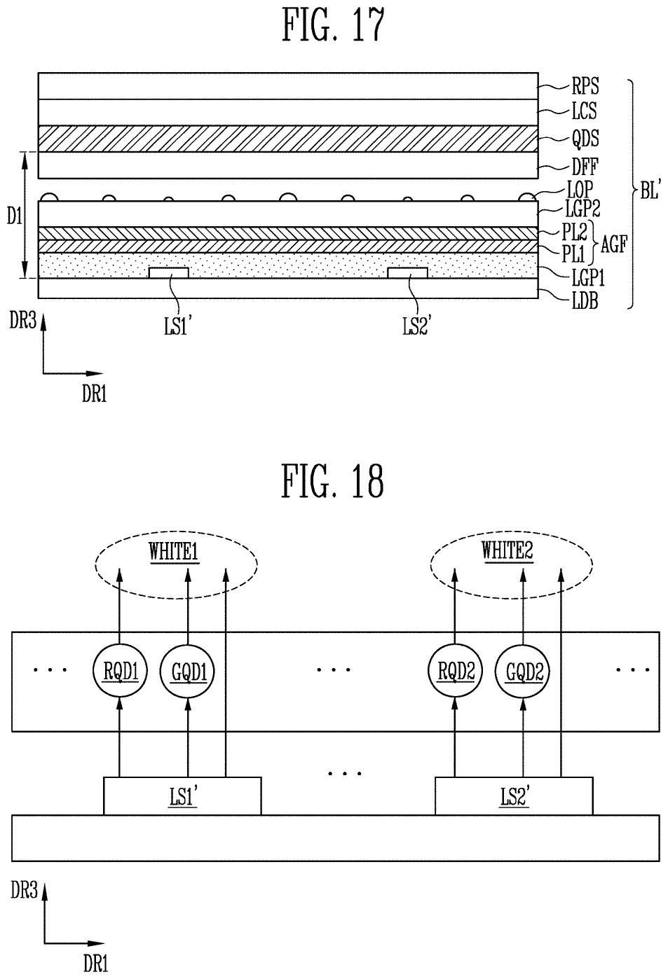

FIG. 17 is a diagram illustrating a backlight in accordance with another embodiment of the present disclosure, and FIG. 18 is a diagram illustrating a color conversion layer.

Unlike the backlight BL of FIG. 5, the backlight BL′ of FIG. 17 may further include the color conversion layer QDS. For example, the color conversion layer QDS may be disposed between the diffusion layer DFF and the light-concentrating layer LCS.

Here, light sources LS1′ and LS2′ may emit light having colors other than white. For example, the light sources LS1′ and LS2′ may emit light of a first color. For example, the first color may be blue. For example, the light sources LS 1′ and LS2′ may be a blue LED that emits blue light if power is applied.

The color conversion layer QDS may convert the color of the light emitted from the light sources LS1′ and LS2′ and then emit white light. For example, the color conversion layer QDS may be a quantum dot sheet. Here, the color conversion layer QDS may include second color quantum dots RQD1 and RQD2 that emit the light of a second color, and third color quantum dots GQD1 and GQD2 that emit the light of a third color, if light is irradiated. For example, the second color may be red, and the third color may be green. For example, the quantum dot may be composed of a core, a shell, and a ligand.

According to an embodiment, the first color, the second color, and the third color may not be blue, red, and green. For example, the first color, the second color, and the third color may be red, blue, and green. As another example, the first color, the second color, and the third color may be green, blue, and red. Since the quantum dot has a band gap varying depending on the size of a core, and the wavelength of the emitted light, namely, the color is determined depending on the band gap, the color may be set in various ways. Hereinafter, for the convenience of description, it is assumed that the first color is blue, the second color is red, and the third color is green.

For example, if the blue light is emitted from the first light source LS1′, light that is not incident on the quantum dots RQD1 and GQD1 may pass through the quantum dot sheet to maintain a blue color. On the other hand, light emitted from the first light source LS1′ and incident on the second color quantum dot RQD1 may be converted into red light. Furthermore, light emitted from the first light source LS1′ and incident on the third color quantum dot GQD1 may be converted into green light. Accordingly, since blue light, red light, and green light are emitted from the color conversion layer QDS, it can be seen that white light WHITE1 generated by combining the lights is emitted. In a similar manner, white light WHITE2 may be emitted.

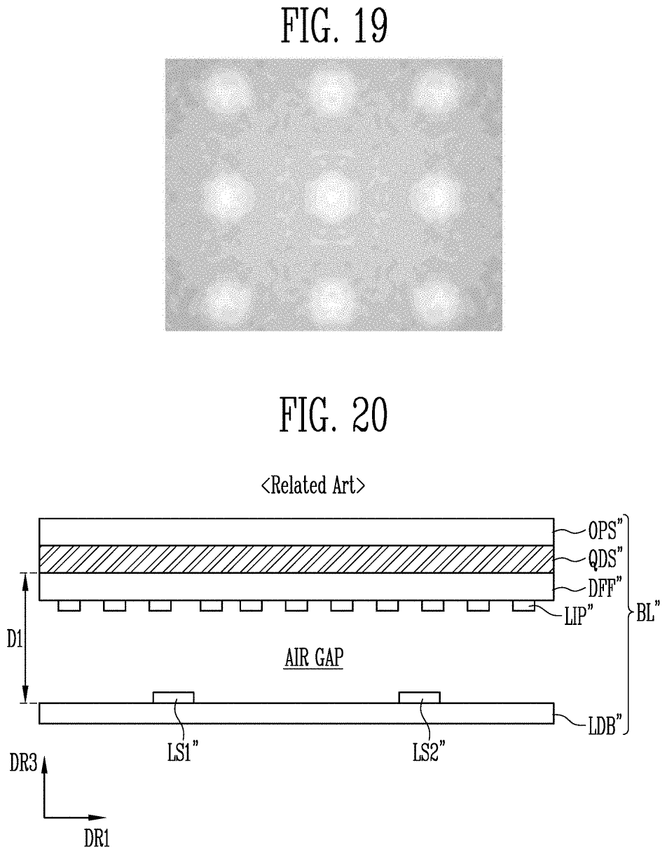

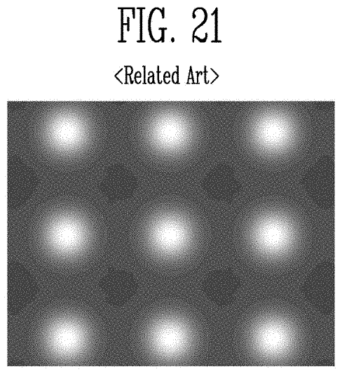

FIG. 19 is a diagram illustrating the simulation result of the backlight in accordance with another embodiment of the present disclosure, FIG. 20 is a diagram illustrating a conventional backlight, and FIG. 21 is a diagram illustrating the simulation result of the conventional backlight.

FIG. 19 illustrates the simulation result of the luminance profile of the backlight BL′, when the distance D1 from the upper surface of the light source board LDB to the upper surface of the diffusion light DFF is 3 mm in the backlight BL′.

The thickness of the first light guide layer LGP1 may be determined within the range of about 0.5 mm to about 2 mm. The thickness of the second light guide layer LGP2 may be determined within the range of about 0.3 mm to about 2 mm. The thicknesses of the angular filter AGF and the fibrous diffusion layer DFF may be negligibly small. The thicknesses of the first light guide layer LGP1 and the second light guide layer LGP2 may be selected such that the distance D1 is about 3 mm.

In FIG. 19, the maximum luminance is about 1.3 times as high as the minimum luminance.

A conventional backlight BL″ of FIG. 20 may include a light source board LDB″, light sources LS1″ and LS2″, a diffusion layer DFF″, light input patterns LIP″ disposed on a bottom of the diffusion layer, a color conversion layer QDS″, and an optical sheet OPS″.

FIG. 21 illustrates the simulation result of the luminance profile of the backlight BL″, when the distance D1 from the upper surface of the light source board LDB″ to the upper surface of the diffusion light DFF″ is about 3 mm in the backlight BL″.

In FIG. 21, the maximum luminance is about 3.8 times as high as the minimum luminance.

Therefore, it can be seen that the backlight BL′ according to this embodiment is smaller in luminance difference than the backlight BL″ according to the related art. Therefore, the backlight BL′ according to this embodiment may be configured to be thinner than the backlight BL″ according to the related art.

Furthermore, as the thickness of the backlight BL′ is reduced, the light efficiency of the backlight BL′ may be increased. That is, as the quantity of light absorbed by each layer of the backlight BL′ is reduced, a luminance level similar to that of the conventional backlight can be achieved even with a smaller number of light sources LS 1′ and LS2′.

According to the simulation result, it can be seen that, based on a 31.5-inch display device DD, the number of the light sources LS1′ and LS2′ formed of LEDs may be reduced from about 7000-8000 to about 2000.

The backlight according to the present disclosure can reduce a thickness and provide light of uniform luminance.

Furthermore, since the backlight according to the present disclosure increases light efficiency due to a reduction in thickness, the backlight can show a luminance level similar to that of a conventional backlight even with a smaller number of light sources.

The detailed description of the disclosure described with reference to the drawings is merely illustrative, which is used only for the purpose of describing the disclosure and is not used to limit the meaning or scope of the disclosure as defined in the accompanying claims. Therefore, those skilled in the art will understand that various modifications and equivalences thereof are possible. Accordingly, the true scope of the present disclosure should be determined by the technical spirit of the accompanying claims.

What is claimed is:

1. A backlight comprising:
a light source board;
light sources disposed on the light source board;
an angular filter disposed on the light source board and the light sources; and
a first light guide layer disposed between the light source board and the angular filter and covering the light sources.

2. The backlight according to claim 1, wherein the first light guide layer is a transparent resin layer.

3. The backlight according to claim 2, wherein the first light guide layer is made of silicon resin.

4. The backlight according to claim 1, wherein the angular filter comprises a plurality of polymer layers.

5. The backlight according to claim 4, wherein the plurality of polymer layers has a structure in which first and second polymer layers are alternately stacked.

6. The backlight according to claim 5, wherein the first and second polymer layers have different refractive indices.

7. The backlight according to claim 1,
wherein the angular filter has first light transmissivity in a first incident-angle range that is lower than second light transmissivity in a second incident-angle range, and
wherein incident angle of the first incident-angle range is smaller than incident angle of the second incident-angle range.

8. The backlight according to claim 7,
wherein the first incident-angle range comprises incident angles of about 30 degrees or less,
wherein the second incident-angle range comprises incident angles of about 50 to about 70 degrees,
wherein the first light transmissivity is less than about 10%, and
wherein the second light transmissivity is about 40% or more.

9. The backlight according to claim 1, further comprising a second light guide layer positioned on the angular filter,
wherein the second light guide layer comprises light output patterns.

10. The backlight according to claim 9,
wherein the second light guide layer comprises a first region and a second region having the same area as the first region,
wherein the first region overlaps at least one of the light sources,
wherein the second region does not overlap any of the light sources, and
wherein a sum of areas of the light output patterns in the first region is smaller than a sum of areas of the light output patterns in the second region.

11. The backlight according to claim 9,
wherein the light output patterns comprise a first light output pattern, a second light output pattern, and a third light output pattern that are sequentially arranged in a first direction,
wherein a distance between a center of the first light output pattern and a center of the second light output pattern is equal to a distance between the center of the second light output pattern and a center of the third light output pattern,
wherein an area of the second light output pattern is larger than an area of the first light output pattern, and
wherein an area of the third light output pattern is larger than an area of the second light output pattern.

12. The backlight according to claim 11,
wherein the light output patterns further comprise a fourth light output pattern and a fifth light output pattern that are sequentially arranged in a second direction from the first light output pattern,
wherein the second direction is different from the first direction,
wherein a distance between the center of the first light output pattern and a center of the fourth light output pattern is equal to a distance between the center of the fourth light output pattern and a center of the fifth light output pattern,
wherein an area of the fourth light output pattern is larger than the area of the first light output pattern, and
wherein an area of the fifth light output pattern is larger than the area of the fourth light output pattern.

13. The backlight according to claim 9,
wherein the light output patterns comprise a first light output pattern, a second light output pattern, and a third light output pattern that are sequentially arranged in a first direction,
wherein areas of the first light output pattern, the second light output pattern, and the third light output pattern are equal to each other, and
wherein a distance between a center of the first light output pattern and a center of the second light output pattern is larger than a distance between the center of the second light output pattern and a center of the third light output pattern.

14. The backlight according to claim 13,
wherein the light output patterns further comprise a fourth light output pattern and a fifth light output pattern that are sequentially arranged in a second direction from the first light output pattern,
wherein the second direction is different from the first direction,
wherein areas of the first light output pattern, the fourth light output pattern, and the fifth light output pattern are equal to each other, and
wherein a distance between a center of the first light output pattern and a center of the fourth light output pattern is larger than a distance between the center of the fourth light output pattern and a center of the fifth light output pattern.

15. A backlight comprising:
a light source board;
light sources disposed on the light source board; and
a light guide layer disposed on the light source board and the light sources,
wherein the light guide layer comprises light output patterns,
wherein the light guide layer comprises a first region and a second region having the same area as the first region,
wherein the first region overlaps at least one of the light sources,
wherein the second region does not overlap any of the light sources, and
wherein a sum of areas of the light output patterns in the first region is smaller than a sum of areas of the light output patterns in the second region.

16. The backlight according to claim 15,
wherein the light output patterns comprise a first light output pattern, a second light output pattern, and a third light output pattern that are sequentially arranged in a first direction,
wherein a distance between a center of the first light output pattern and a center of the second light output pattern is equal to a distance between the center of the second light output pattern and a center of the third light output pattern,
wherein an area of the second light output pattern is larger than an area of the first light output pattern, and
wherein an area of the third light output pattern is larger than an area of the second light output pattern.

17. The backlight according to claim 16,
wherein the light output patterns further comprise a fourth light output pattern and a fifth light output pattern that are sequentially arranged in a second direction from the first light output pattern,
wherein the second direction is different from the first direction,
wherein a distance between the center of the first light output pattern and a center of the fourth light output pattern is equal to a distance between the center of the fourth light output pattern and a center of the fifth light output pattern,
wherein an area of the fourth light output pattern is larger than the area of the first light output pattern, and
wherein an area of the fifth light output pattern is larger than the area of the fourth light output pattern.

18. The backlight according to claim 15,
wherein the light output patterns comprise a first light output pattern, a second light output pattern, and a third light output pattern that are sequentially arranged in a first direction,
wherein areas of the first light output pattern, the second light output pattern, and the third light output pattern are equal to each other, and
wherein a distance between a center of the first light output pattern and a center of the second light output pattern is larger than a distance between the center of the second light output pattern and a center of the third light output pattern.

19. The backlight according to claim 16,
wherein the light output patterns further comprise a fourth light output pattern and a fifth light output pattern that are sequentially arranged in a second direction from the first light output pattern,
wherein the second direction is different from the first direction,
wherein areas of the first light output pattern, the fourth light output pattern, and the fifth light output pattern are equal to each other, and
wherein a distance between a center of the first light output pattern and a center of the fourth light output pattern is larger than a distance between the center of the fourth light output pattern and a center of the fifth light output pattern.

20. The backlight according to claim 15, further comprising an angular filter having first light transmissivity in a first incident-angle range,
wherein the first light transmissivity is lower than second light transmissivity in a second incident-angle range, and
wherein incident angle of the first incident-angle range is smaller than incident angle of the second incident-angle range.
